(19) United States
(12) Patent Application Publication
(10) Pub. No.: US 2024/0167404 A1
(43) Pub. Date: May 23, 2024

(54) MUFFLER STRUCTURE

(71) Applicant: Honda Motor Co., Ltd., Tokyo (JP)

(72) Inventor: Fumiaki MURAKAMI, Tokyo (JP)

(73) Assignee: Honda Motor Co., Ltd., Tokyo (JP)

(21) Appl. No.: 18/492,790

(22) Filed: Oct. 24, 2023

(30) Foreign Application Priority Data
Nov. 23, 2022 (CN) 202223107493.8

(51) Int. Cl. F01N 1/08

(52) U.S. Cl. CPC F01N 1/084

(57) ABSTRACT

A muffler structure is arranged on an exhaust pathway of an internal combustion engine and includes a pipe having a bent portion. Further, a vortex generating portion is arranged on an upstream side of the bent portion of the pipe in the exhaust pathway.

### CROSS-REFERENCE TO RELATED APPLICATION

This application claims the priority benefit of China application serial no. 202223107493.8, filed on Nov. 23, 2022. The entirety of the above-mentioned patent application is hereby incorporated by reference herein and made a part of this specification.

### BACKGROUND

### Technical Field

The disclosure relates to a muffler structure.

### Description of Related Art

In the related art, in order for the noise of the low-frequency component (secondary sound) of the noise generated by an engine to be effectively eliminated, it is necessary to reduce the diameter of the pipe and extend the length of the pipe. However, the above measures also lead to a contradicting situation of an increase in the overall intensity of the airflow noise for the following reasons. For instance, when the size of the exhaust pipe is reduced, the gas flow velocity inside the pipe increases, which leads to an increase in airflow noise. Alternatively, when the pipe length is extended, the bending angle and bending radius of the exhaust pipe decrease due to the limitation of the internal space of the muffler, which may lead to an increase in the gas flow velocity. An increase in pressure loss and an increase in the flow velocity of part of the gas due to flow bias may also lead to an increase in airflow noise. However, with the promotion of noise regulations in various countries, reducing airflow noise has become a subject that needs to be addressed.

### SUMMARY

The disclosure provides a muffler structure capable of effectively reducing airflow noise.

The disclosure provides a muffler structure arranged on an exhaust pathway of an internal combustion engine, and the muffler structure includes a pipe having a bent portion. A vortex generating portion is arranged on an upstream side of the bent portion of the pipe in the exhaust pathway.

To sum up, in the muffler structure provided by the disclosure, through the arrangement of the vortex generating portion in the muffler structure, the flow resistance of the gas is increased on the upstream side of the bent portion of the pipe, and the flow velocity of the gas is thus decreased. In this way, the phenomenon that the airflow is separated from the pipe wall is suppressed, and the increase of the airflow noise is further suppressed.

To make the aforementioned more comprehensible, several embodiments accompanied with drawings are described in detail as follows.

### BRIEF DESCRIPTION OF THE DRAWINGS

FIG. 1 is a schematic view showing an exhaust system including a muffler structure according to an embodiment of the disclosure.

FIG. 2 is a schematic view of an internal structure of the muffler structure shown in FIG. 1.

FIG. 3 is a schematic perspective view of an exhaust pipe of the muffler structure shown in FIG. 1.

FIG. 4 is a schematic cross-sectional view of the exhaust pipe shown in FIG. 3.

FIG. 5A to FIG. 5F are schematic views of various contours of vortex generating portions according to an embodiment of the disclosure.

FIG. 6 is a schematic diagram of directions of airflow inside the muffler structure shown in FIG. 1.

FIG. 7A to FIG. 7C are schematic diagrams of airflow streamlines when the airflow does not pass through or passes through different vortex generating portions.

FIG. 7D is a schematic diagram of air flow streamlines when the airflow passes through a bent portion.

FIG. 8A to FIG. 8C are schematic views of structures of the exhaust pipe according to an embodiment of the disclosure.

FIG. 9 is a schematic view of the structure of the exhaust pipe according to an embodiment of the disclosure.

FIG. 10A is a schematic view of the structure of the exhaust pipe according to an embodiment of the disclosure.

FIG. 10B is a local enlargement view of FIG. 10A.

FIG. 11A and FIG. 11B are schematic views of the structures of the exhaust pipe according to an embodiment of the disclosure.

### DESCRIPTION OF THE EMBODIMENTS

The disclosure provides a muffler structure arranged on an exhaust pathway of an internal combustion engine, and the muffler structure includes a pipe having a bent portion. A vortex generating portion is arranged on an upstream side of the bent portion of the pipe in the exhaust pathway.

In an embodiment of the disclosure, the vortex generating portion is a hole portion or a stepped portion. When the vortex generating portion is the hole portion, the vortex generating portion communicates with the inside and outside of the pipe.

In an embodiment of the disclosure, the vortex generating portion is arranged on an inner side of the pipe.

In an embodiment of the disclosure, the stepped portion includes a convex portion or a concave portion.

In an embodiment of the disclosure, the vortex generating portion is arranged on the upstream side of the bent portion. A distance between the vortex generating portion and the bent portion is 150 mm or less.

In an embodiment of the disclosure, the muffler structure has an expansion chamber.

In an embodiment of the disclosure, the expansion chamber is divided into a plurality of spaces by a separator. The separator has a plurality of holes, and the separator supports the pipe.

In an embodiment of the disclosure, the pipe includes a first pipe having the bent portion and a second pipe connected to the first pipe and having a straight portion. A connecting portion between the first pipe and the second pipe is formed with a gap. The gap functions as the vortex generating portion.

In an embodiment of the disclosure, the pipe includes a first pipe having the bent portion and a second pipe connected to the first pipe and having a straight portion. An end portion of the first pipe or the second pipe is corrugated. The end portion functions as the vortex generating portion.

In an embodiment of the disclosure, the pipe includes a first pipe having the bent portion and a second pipe connected to the first pipe and having a straight portion. An end portion of the first pipe or the second pipe is bent. The end portion functions as the vortex generating portion.

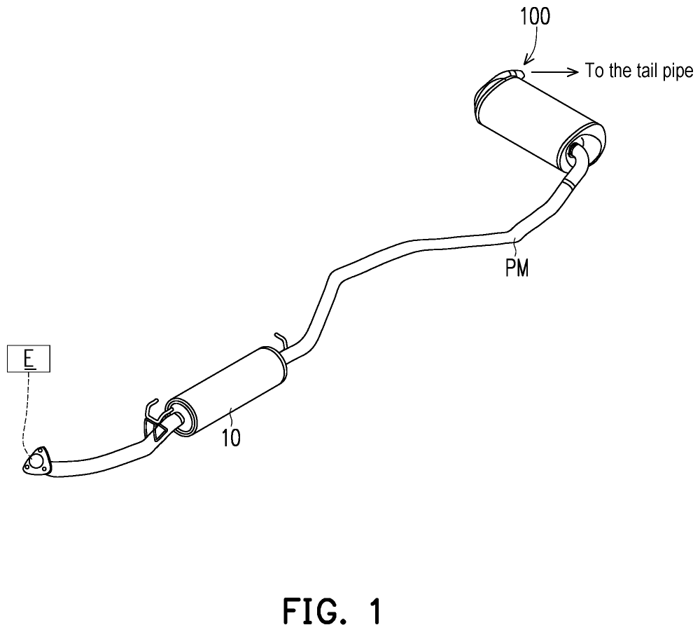

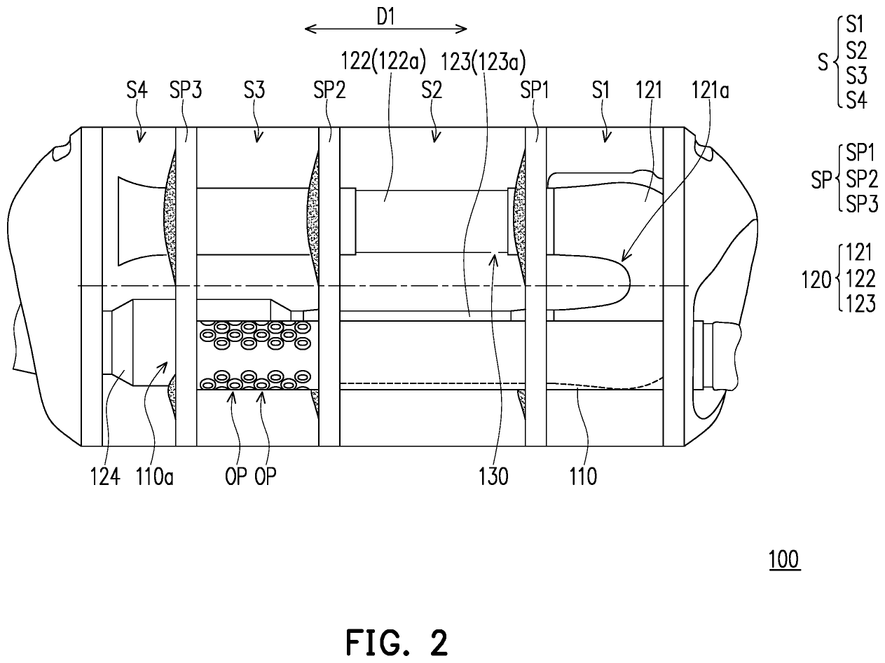

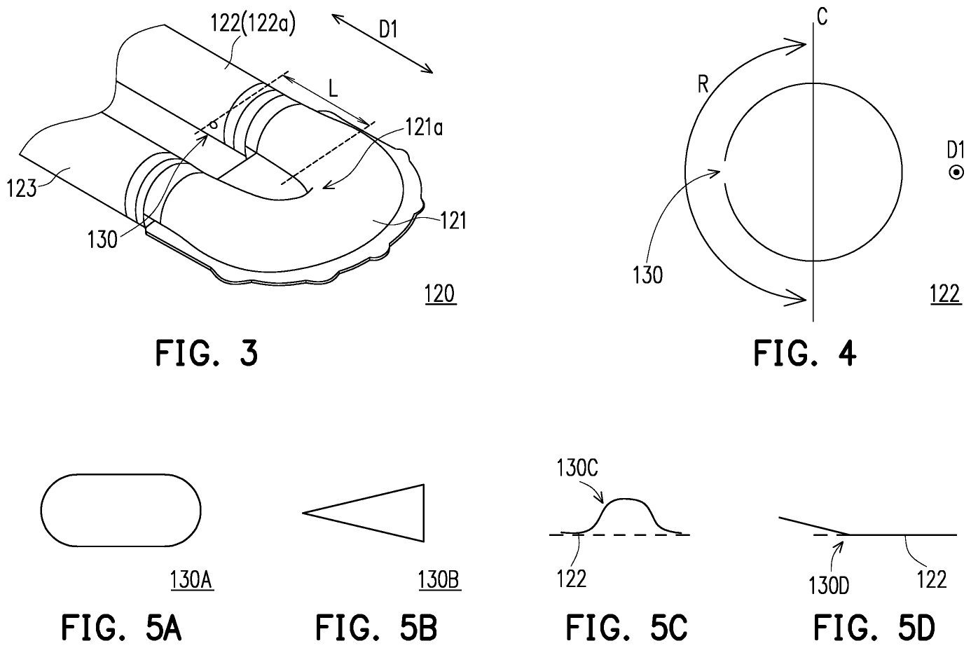

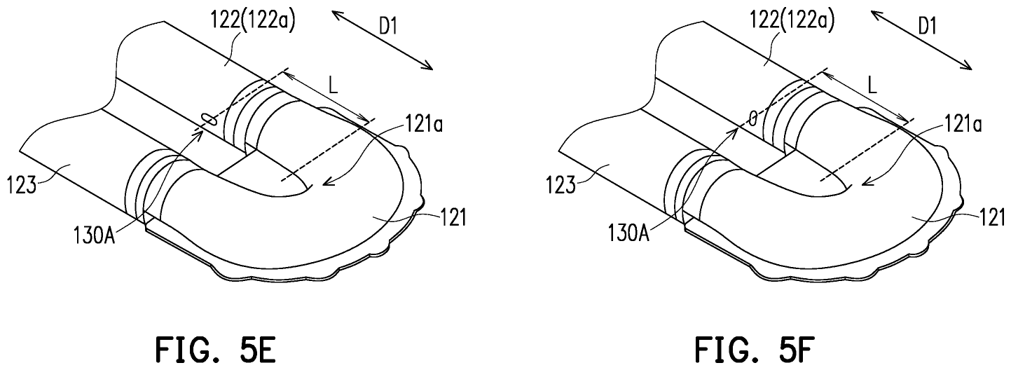

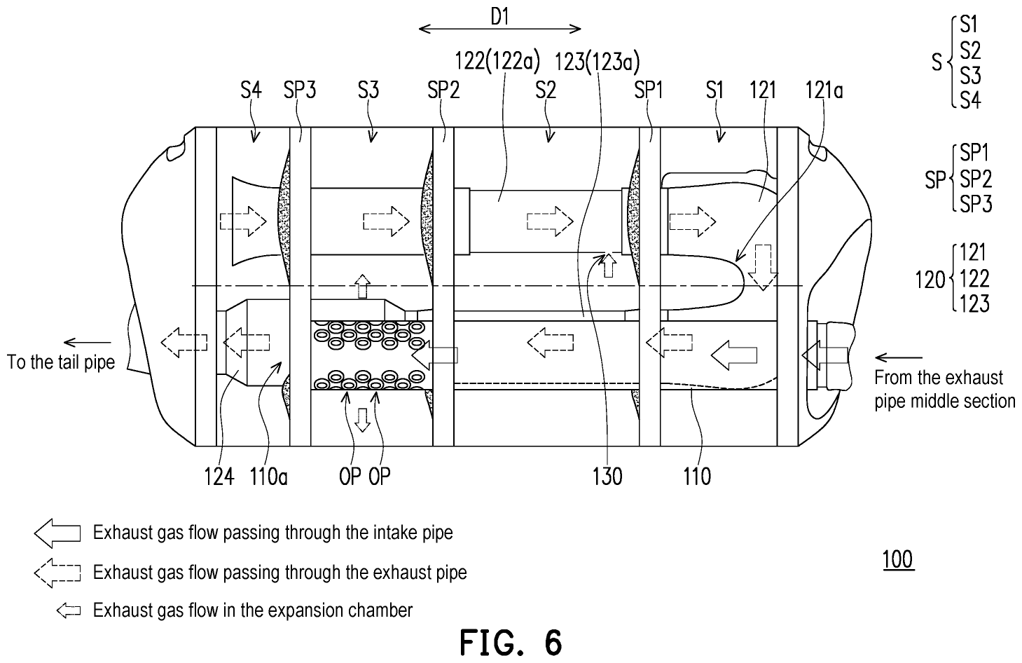

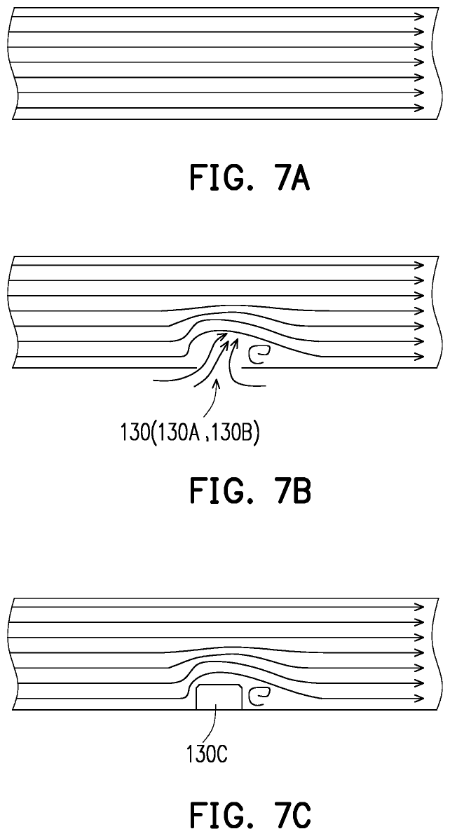

FIG. 1 is a schematic view showing an exhaust system including a muffler structure according to an embodiment of the disclosure. FIG. 2 is a schematic view of an internal structure of the muffler structure shown in FIG. 1. FIG. 3 is a schematic perspective view of an exhaust pipe of the muffler structure shown in FIG. 1. FIG. 4 is a schematic cross-sectional view of the exhaust pipe shown in FIG. 3. FIG. 5A to FIG. 5F are schematic views of various contours of vortex generating portions according to an embodiment of the disclosure. FIG. 6 is a schematic diagram of directions of airflow inside the muffler structure shown in FIG. 1. In this embodiment, a muffler structure 100 refers to the muffler structure arranged between an exhaust pipe middle section PM and a tail pipe in an exhaust system of an internal combustion engine E. The specific structure of the muffler structure 100 is to be described below with reference to FIG. 1 to FIG. 6.

With reference to FIG. 1, in this embodiment, the muffler structure 100 is arranged on an exhaust pathway of the internal combustion engine E and is configured to eliminate the noise of the airflow passing through the muffler structure 100. To be more specific, as shown in FIG. 1, a catalyst (not shown), a pre-chamber 10 acting as an auxiliary muffler, and the muffler structure 100 are sequentially connected in series from the upstream side to the downstream side of the exhaust pipe in the exhaust pathway of the internal combustion engine E. The exhaust gas discharged from the internal combustion engine E passes through the catalyst to purify harmful components such as HC, CO, and NOx, and then flows in the pre-chamber 10 to perform auxiliary noise reduction, flows to the muffler structure 100 next through the exhaust pipe middle section PM in the exhaust system, flows in the muffler structure 100 to mainly perform noise reduction, and is discharged from the tail pipe.

Further, as shown in FIG. 2, in this embodiment, the muffler structure 100 has an expansion chamber S and includes an intake pipe 110 and an exhaust pipe 120. The expansion chamber S is divided into a plurality of spaces by a separator SP. Further, as shown in FIG. 2, the inside of the muffler structure 100 is divided into a first space S1, a second space S2, a third space S3, and a fourth space S4 by a first separator SP1, a second separator SP2, and a third separator SP3 from an upstream direction. The separator SP has a plurality of holes and allows the plurality of spaces to communicate with one another. Therefore, the expansion chamber S of the muffler structure 100 may be treated as a whole, and there is no expansion sequence. On the other hand, the separator SP may be used to support the intake pipe 110 and the exhaust pipe 120.

On the other hand, as shown in FIG. 2, in this embodiment, the intake pipe 110 and the exhaust pipe 120 passes through the first space S1, the second space S2, the third space S3, and the fourth space S4 inside the muffler structure 100 and thus allow the exhaust gas from the exhaust pipe middle section PM to circulate. Further, the intake pipe 110 extends in a length direction D1 in the expansion chamber S and has a plurality of small holes OP (punching holes) and a tail end opening 110a, so that the inflowing exhaust gas may be discharged into the expansion chamber S. On the other hand, as shown in FIG. 2 and FIG. 3, in this embodiment, the exhaust pipe 120 is arranged below the intake pipe 110 and includes a first pipe 121, a second pipe 122, a third pipe 123, and a sound-absorbing material pipe 124. Herein, the first pipe 121 has a bent portion 121a. The second pipe 122 and the third pipe 123 are connected to both ends of the first pipe 121 and have straight portions 122a and 123a extending in the length direction D1 of the muffler structure 100. To be more specific, as shown in FIG. 2 and FIG. 3, one end of the second pipe 122 is connected to one end of the first pipe 121 away from the intake pipe 110, and the other end of the second pipe 122 has an opening away from the first pipe 121. One end of the third pipe 123 is connected to the end of the first pipe 121 close to the intake pipe 110, and the other end is connected to the sound-absorbing material pipe 124. Both the third pipe 123 and the sound-absorbing material pipe 124 are overlapped with the intake pipe 110 in an up-down direction. An outer diameter of the sound-absorbing material pipe 124 is greater than that of the third pipe 123, and the sound-absorbing material pipe 124 is located between the tail pipe and the third pipe 123. For instance, the sound-absorbing material pipe 124 is a structure in which glass wool is wound on the pipe and may be used to further eliminate noise at an outlet of the muffler structure 100.

Further, as shown in FIG. 3 and FIG. 4, in this embodiment, a vortex generating portion 130 is arranged on an upstream side of the bent portion 121a of the exhaust pipe 120. The vortex generating portion 130 is arranged on an inner side the second pipe 122 of the exhaust pipe 120. As shown in FIG. 4, in this embodiment, the inner side refers to a pipe wall range R close to the third pipe 123 that is bounded by a central diameter C passing through a center of the pipe and starting from a point between the pipe and the central diameter C and ending at another point between the pipe and the central diameter C. For instance, in this embodiment, the vortex generating portion 130 is arranged at the center of the pipe wall range R. That is, when a central angle of an intersection point of the pipe and the central diameter C is zero degrees, the vortex generating portion 130 is arranged at a pipe wall position closest to the third pipe 123 with a central angle of 90 degrees. To be specific, as shown in FIG. 3, in this embodiment, the vortex generating portion 130 is arranged on the upstream side of the bent portion 121a, and a distance L between the vortex generating portion 130 and a starting point of the bent portion 121a is 150 mm or less.

For instance, in this embodiment, the vortex generating portion 130 is a hole portion and communicates with the inside and outside of the pipe, and a contour of the hole portion is circular, but the disclosure is not limited thereto. In other embodiments, as shown in FIG. 5A and FIG. 5B, the contour of the hole portion may be other shapes, and the hole portion functions as vortex generating portions 130A and 130B. Alternatively, as shown in FIG. 5C and FIG. 5D, the vortex generating portion may be formed as a stepped portion by changing the contour of the pipe wall of the second pipe 122 and functions as vortex generating portions 130C and 130D. For instance, as shown in FIG. 5A and FIG. 5B, the vortex generating portion 130A may be a slot having an elliptical bent contour, and the vortex generating portion 130B may be a slot having a triangular contour. Further, as shown in FIG. 5E and FIG. 5F, when the vortex generating portion 130A is a slot having an elliptical bent contour, its length direction D1 may extend in an extending direction of the second pipe 122 or in a circumferential direction of the second pipe 122.

As such, in the above arrangement, a downstream end of the exhaust pipe middle section PM is connected to the intake pipe 110. In this way, the exhaust gas of the internal combustion engine E from the exhaust pipe flows into the intake pipe 110 of the muffler structure 100 from the right side in the length direction D1 of the muffler structure 100. Further, the exhaust gas flowing in the intake pipe 110 of the muffler structure 100 is discharged into the expansion chamber S through the small holes OP of the intake pipe 110 and the tail end opening 110a. A cross-sectional area of a cavity of the expansion chamber S is greater than a cross-sectional area of the exhaust pipe middle section PM or a passage cross-sectional area of the intake pipe 110 and the exhaust pipe 120. In this way, by expanding the exhaust gas in the expansion chamber S, the speed and pressure of exhaust gas circulation may be reduced. Further, the outlet of the muffler structure 100 can only allow energy whose magnitude is reduced by expansion corresponding to an opening area of the outlet to pass through. Further, the remaining energy is attenuated by reflection in the expansion chamber S, so that the noise of the exhaust gas passing through the muffler structure 100 may be eliminated. The exhaust gas in the expansion chamber S enters the exhaust pipe 120 through the opening at the other end of the second pipe 122, flows through the first pipe 121, the second pipe 122, the third pipe 123, and the sound-absorbing material pipe 124 in sequence, and is discharged to the tail pipe. In this way, the exhaust gas entering from the intake pipe 110 located at one end of the muffler structure 100 may be discharged to the expansion chamber S and then discharged to the outside from the other end of the muffler structure 100 through the exhaust pipe 120 after being expanded in the expansion chamber S to reduce the noise.

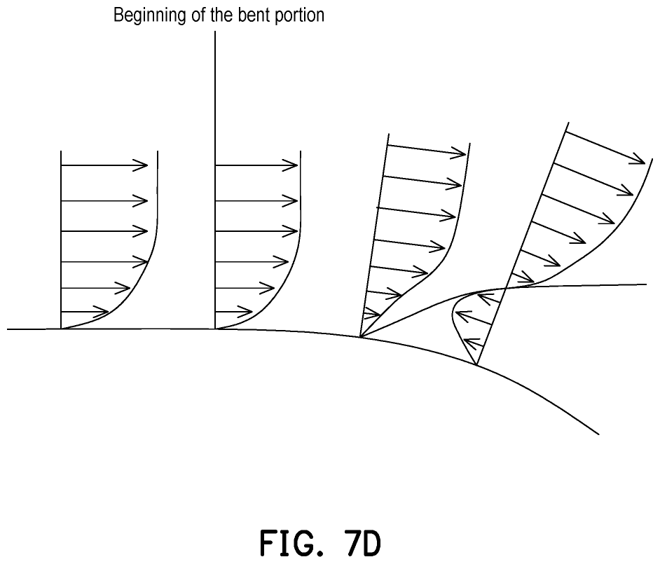

Further, in this embodiment, the exhaust gas flowing in the exhaust pipe 120 may first pass through the vortex generating portion 130 before flowing through the bent portion 121a, so that the flow resistance of the gas may be increased and the flow velocity of the gas may be reduced, and that an increase in airflow noise may be further suppressed. The function of the vortex generating portion 130 is to be further described below with reference to FIG. 7A to FIG. 7D.

FIG. 7A to FIG. 7C are schematic diagrams of airflow streamlines when the airflow does not pass through or passes through different vortex generating portions 130. FIG. 7D is a schematic diagram of air flow streamlines when the airflow passes through the bent portion 121a. To be specific, as shown in FIG. 7A, when the airflow passes through the flat pipe wall, the flow direction of the airflow remains stable. As shown in FIG. 7B, when the hole portion (e.g., the vortex generating portions 130, 130A, and 130B) is provided on the pipe wall, the flow velocity of the airflow flowing in from the hole portion is slower than the flow velocity of the airflow flowing in the pipe, so the flow velocity of the overall airflow is slowed down. To be more specific, as shown in FIG. 7B, a large vortex is formed behind the confluence of the airflow flowing in from the hole portion and the airflow in the pipe, so that the flow resistance is further increased, and the flow velocity of the overall airflow is thus reduced. On the other hand, as shown in FIG. 7C, when the pipe wall is provided with the stepped portion (e.g., the vortex generating portion 130C), since the cross-sectional area of pathway changes at the stepped portion, the flow direction and the flow velocity of the airflow change accordingly, so a vortex is generated behind the airflow passing through the stepped portion as well. Therefore, the flow resistance is increased, and the flow velocity of the overall airflow is reduced. Generally, compared to the installation of the hole portion, the arrangement of the stepped portion reduces the flow velocity of the entire airflow much smaller than that of the arrangement of the hole portion. In this way, by arranging the vortex generating portion 130 (or the vortex generating portions 130A, 130B, 130C, and 130D) on the upstream side of the bent portion 121a and the distance L between the vortex generating portion 130 and the starting point of the bent portion 121a to be 150 mm or less, the flow velocity of the exhaust gas flow of exhaust gas flowing in the exhaust pipe 120 may be effectively reduced before the exhaust gas passes through the bent portion 121a.

On the other hand, FIG. 7D shows the change of the flow direction of the airflow when the airflow passes through the bent portion. When the airflow passes through the bent portion, as the bending angle increases, due to an increase in pressure loss and an increase in the flow velocity of part of the gas, the flow velocity near the pipe wall may increase and the shear stress separating the airflow from the pipe wall may increase, so the amount of airflow separating from the pipe wall increases, and the noise of the airflow thus grows. For instance, as shown in FIG. 6, the bending angle of the bent portion 121a is 180 degrees. However, as shown in FIG. 7D, as long as the bending angle is greater than approximately 15 degrees, airflow separation begins, so the noise of the airflow increases. Further, as the bending angle increases, the noise of the airflow increases more obviously. However, in this embodiment, by arranging the vortex generating portion 130 on the upstream side of the bent portion 121a and at the center of the inner side of the pipe wall closest to the third pipe 123, at the position of the pipe wall where airflow separation is most likely to occur, the flow velocity of the gas may be reduced before the gas flows through the bent portion 121a. Moreover, the amount of the airflow separated from the pipe wall may be effectively reduced, so the noise of the airflow may be further eliminated.

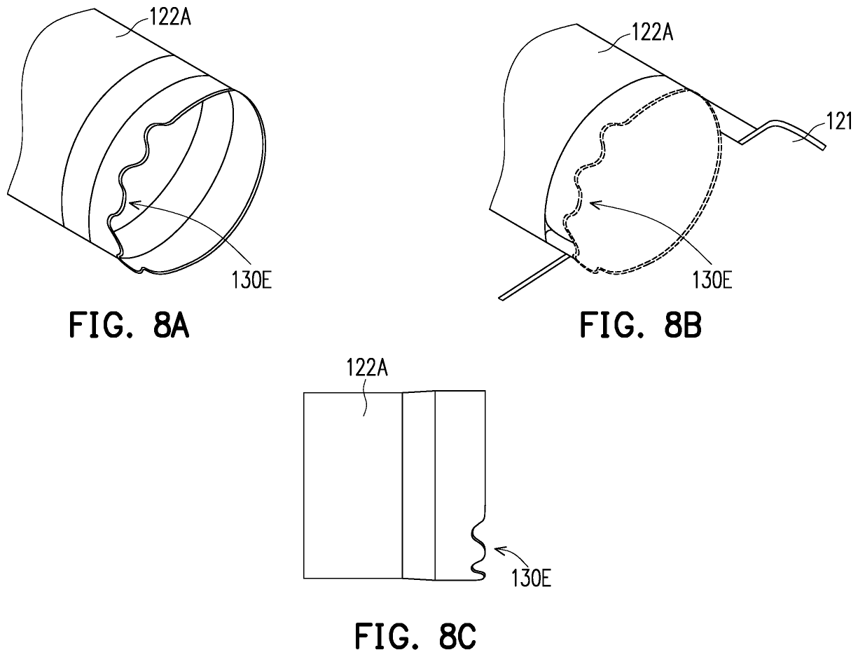

In the foregoing embodiments, each of the vortex generating portions 130, 130A, 130B, 130C, and 130D is exemplified by the hole portion or the stepped portion, but the disclosure is not limited thereto. In other embodiments, the vortex generating portion may also be formed with other structures. The following description is made with reference to FIG. 8A to FIG. 11B.

FIG. 8A to FIG. 8C are schematic views of structures of the exhaust pipe according to an embodiment of the disclosure. As shown in FIG. 8A to FIG. 8C, in this embodiment, an end portion of the second pipe 122A is corrugated. In this way, a vortex may also be generated after the airflow passes through the end portion of the second pipe 122A, and that the flow resistance is increased, the flow velocity of the entire airflow is reduced, and the noise of the airflow is thus eliminated. That is, the corrugated end portion of the second pipe 122A functions as a vortex generating portion 130E. However, the disclosure is not limited thereto, and in another embodiment that is not shown, the corrugated end portion may also be arranged at one end of the first pipe connected to the second pipe and thus may also function as the vortex generating portion 130E.

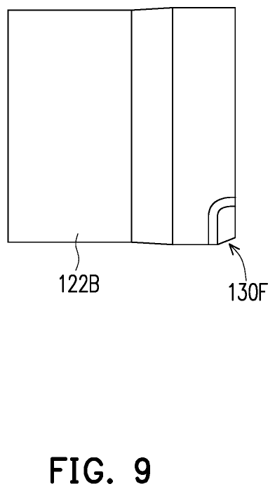

FIG. 9 is a schematic view of the structure of the exhaust pipe according to an embodiment of the disclosure. As shown in FIG. 9, in this embodiment, an end portion of a second pipe 122B may extend in a bent shape along the contour in the length direction, so that a function similar to that of the stepped portion is provided, and the end portion functions as a vortex generating portion 130F. Further, the disclosure is not limited thereto as well, and in another embodiment that is not shown, the bent end portion may also be arranged at one end of the first pipe connected to the second pipe and thus may also function as the vortex generating portion 130F.

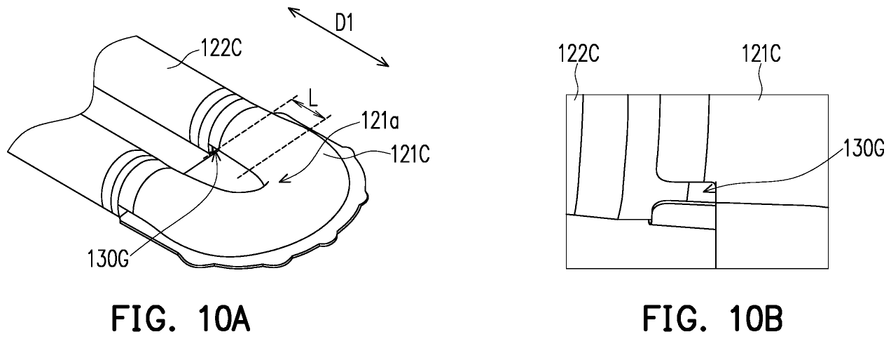

FIG. 10A is a schematic view of the structure of the exhaust pipe according to an embodiment of the disclosure. FIG. 10B is a local enlargement view of FIG. 10A. As shown in FIG. 10A and FIG. 10B, in this embodiment, a connecting portion between a first pipe 121C and a second pipe 122C is formed with a gap to allow the exhaust gas in the expansion chamber S to pass through, so that a function similar to that of the hole portion is provided, and the gap may function as a vortex generating portion 130G. In this way, a vortex may also be generated after the airflow passes through the first pipe 121C and the second pipe 122C, and that the flow resistance is increased, the flow velocity of the entire airflow is reduced, and the noise of the airflow is thus eliminated.

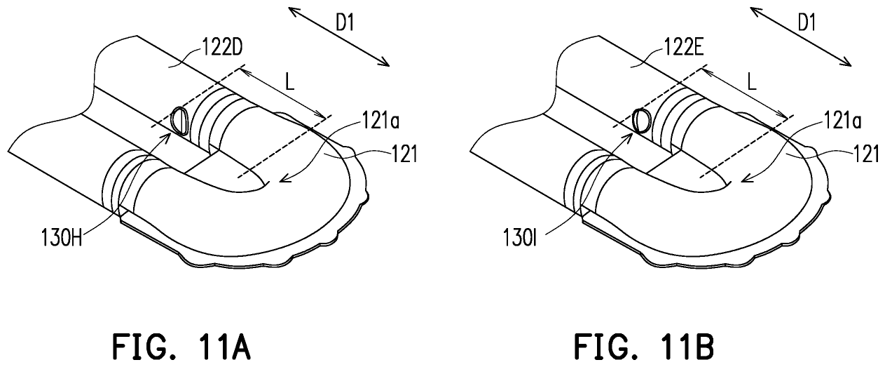

FIG. 11A and FIG. 11B are schematic views of the structures of the exhaust pipe 120 according to an embodiment of the disclosure. In this embodiment, a concave portion as shown in FIG. 11A or a convex portion as shown in FIG. 11B may be provided on the pipe wall of a second pipe 122D on the upstream side of the bent portion 121a, so that a function similar to that of the stepped portion is provided, and the concave portion or the convex portion may function as a vortex generating portion 130G. In this way, a vortex may also be generated after the airflow passes through the concave portion or the convex portion, and that the flow resistance is increased, the flow velocity of the entire airflow is reduced, and the noise of the airflow is thus eliminated.

In view of the foregoing, in the muffler structure provided by the disclosure, through the arrangement of the vortex generating portion in the muffler structure, the flow resistance of the gas is increased on the upstream side of the bent portion of the pipe, and the flow velocity of the gas is thus decreased. In this way, the phenomenon that the airflow is separated from the pipe wall may be suppressed, and the increase of the airflow noise may be further suppressed.

Finally, it is worth noting that the foregoing embodiments are merely described to illustrate the technical solutions of the disclosure and should not be construed as limitations of the disclosure. Even though the foregoing embodiments are referenced to provide detailed description of the disclosure, a person having ordinary skill in the art should understand that various modifications and variations can be made to the technical solutions in the disclosed embodiments, or equivalent replacements may be made for part or all of the technical features. Nevertheless, it is intended that the modifications, variations, and replacements shall not make the nature of the technical solutions to depart from the scope of the technical solutions of the embodiments of the disclosure.

What is claimed is:

1. A muffler structure arranged on an exhaust pathway of an internal combustion engine, the muffler structure comprising:
a pipe having a bent portion, wherein
a vortex generating portion is arranged on an upstream side of the bent portion of the pipe in the exhaust pathway.

2. The muffler structure according to claim 1, wherein the vortex generating portion is a hole portion or a stepped portion, and when the vortex generating portion is the hole portion, the vortex generating portion communicates with the inside and outside of the pipe.

3. The muffler structure according to claim 2, wherein the vortex generating portion is arranged on an inner side of the pipe.

4. The muffler structure according to claim 2, wherein the stepped portion comprises a convex portion or a concave portion.

5. The muffler structure according to claim 2, wherein the vortex generating portion is arranged on the upstream side of the bent portion, and a distance between the vortex generating portion and the bent portion is 150 mm or less.

6. The muffler structure according to claim 1, wherein the muffler structure has an expansion chamber.

7. The muffler structure according to claim 6, wherein the expansion chamber is divided into a plurality of spaces by a separator, the separator has a plurality of holes, and the separator supports the pipe.

8. The muffler structure according to claim 1, wherein
the pipe comprises:
a first pipe having the bent portion; and
a second pipe connected to the first pipe and having a straight portion,
wherein a connecting portion between the first pipe and the second pipe is formed with a gap, and the gap functions as the vortex generating portion.

9. The muffler structure according to claim 1, wherein
the pipe comprises:
a first pipe having the bent portion; and
a second pipe connected to the first pipe and having a straight portion,
an end portion of the first pipe or the second pipe is corrugated, and the end portion functions as the vortex generating portion.

10. The muffler structure according to claim 1, wherein
the pipe comprises:
a first pipe having the bent portion; and
a second pipe connected to the first pipe and having a straight portion,
an end portion of the first pipe or the second pipe is bent, and the end portion functions as the vortex generating portion.
